(19) United States
(12) Patent Application Publication
(10) Pub. No.: US 2021/0230365 A1
(43) Pub. Date: Jul. 29, 2021

(54) POLYASPARTATE COMPOSITIONS

(71) Applicant: Covestro LLC, Pittsburgh, PA (US)

(72) Inventors: Matthew Stewart, Pittsburgh, PA (US); Joseph Pierce, Pittsburgh, PA (US); Michael K. Jeffries, Follansbee, WV (US); Wendy S. Gustavich, Maynard, OH (US); Charles A. Gambino, McDonald, PA (US); Andrew Bradburn, Pittsburgh, PA (US); Robert A. Wade, Oakdale, PA (US); Myron W. Shaffer, New Cumberland, WV (US)

(21) Appl. No.: 17/155,731

(22) Filed: Jan. 22, 2021

Related U.S. Application Data
(60) Provisional application No. 62/964,770, filed on Jan. 23, 2020.

(51) Int. Cl. C08G 69/26; C08G 18/38; C08G 18/73; C09D 175/02

(52) U.S. Cl. CPC C08G 69/26; C08G 18/3819; C08G 2150/00; C09D 175/02; C08G 18/73

(57) ABSTRACT

A polyaspartate composition can include a reaction product of a diamine and an amine-reactive component. The amine reactive-component can include a diester and an acrylate combined at an equivalent ratio of diester equivalents to acrylate equivalents of from less than 0.9:greater than 0.1 to greater than 0.3:less than 0.7. The diamine and the amine-reactive component can be combined at an equivalent ratio of diamine equivalents to amine-reactive component equivalents of from 1:0.8 to 0.8:1.

### BACKGROUND

Two-component coating systems and compositions based on polyurethanes or polyureas are widely used in industry because of the many advantageous properties exhibited by these coating chemistries. Two-component coating systems generally include a liquid binder component and a liquid hardener/crosslinker component. For example, the liquid binder component can include an isocyanate-reactive component such a polyol or polyamine, and the liquid crosslinker component can include a polyisocyanate component. The addition reaction of the polyisocyanate component with the isocyanate-reactive component produces highly crosslinked polyurea or polyurethane networks that form coating compositions that can be applied to a variety of substrates.

### BRIEF DESCRIPTION OF THE DRAWINGS

Invention features and advantages will be apparent from the detailed description which follows, taken in conjunction with the accompanying drawings, which together illustrate, by way of example, various invention embodiments; and, wherein:

FIG. 1 is a plot of gel time vs equivalents of butyl acrylate employed in a polyaspartate reaction mixture;

FIG. 2 is a plot of APHA color vs time for one example of an aspartate composition in accordance with the present disclosure;

FIG. 3 is a plot of amine number vs time for one example of an aspartate composition in accordance with the present disclosure;

FIG. 4 is a plot of APHA color vs time for an example of a comparative composition in accordance with the present disclosure; and

FIG. 5 is a plot of amine number vs time for an example of a comparative composition in accordance with the present disclosure.

Reference will now be made to the exemplary embodiments illustrated, and specific language will be used herein to describe the same. It will nevertheless be understood that no limitation of the scope or to specific invention embodiments is thereby intended.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of language as well as” consisting of language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### EXAMPLE EMBODIMENTS

An initial overview of invention embodiments is provided below and specific embodiments are then described in further detail. This initial summary is intended to aid readers in understanding the technological concepts more quickly, but is not intended to identify key or essential features thereof, nor is it intended to limit the scope of the claimed subject matter.

The present disclosure describes a polyaspartate composition that can include a reaction product of a diamine and an amine-reactive component including a diester and an acrylate present at an equivalent ratio of diester equivalents to acrylate equivalents of from less than 0.9:greater than 0.1 to greater than 0.3:less than 0.7. The diamine and the amine-reactive component can be combined and allowed to react at an equivalent ratio of diamine equivalents to amine-reactive component equivalents of from 1:0.8 to 0.8:1.

In further detail, although many polyurea coatings containing polyaspartate compositions can have a rapid initial cure rate, many polyurea coatings also do not completely cure until much later (e.g., one or more weeks later). As such, quick development of the ultimate physical properties (e.g., hardness, tensile strength, etc.) of the coatings can be delayed. It is further noted that various modifications can be made to the coating compositions to allow for quick development of the final physical properties of the coating, but many modifications can ultimately result in a coating (e.g, a paint, a top coating, etc.) that is much less stable than the unmodified coatings. Therefore, there is a need for polyaspartate coating compositions that can react quickly with polyisocyanates to form a polyurea composition, that can develop the ultimate physical properties of the coating quickly, and that can remain relatively stable.

The present disclosure describes polyaspartate compositions that react quickly with polyisocyanates, that generate ultimate physical properties quickly, and that have good stability. In further detail, the polyaspartate compositions described herein can be the reaction product of a diamine with an amine-reactive component including a combination of a diester and an acrylate. The diamine and the amine-reactive component can be mixed and allowed to react at an equivalent ratio of diamine equivalents to amine-reactive component equivalents (e.g., diester equivalents+acrylate equivalents) of from 1:0.8 to 0.8:1. Thus, for example, for an equivalent ratio of 1:1, the combined amount of diester equivalents and acrylate equivalents can be equal to the total amount of diamine equivalents in the reaction mixture. In some additional examples, the diamine and the amine-reactive component can be combined at an equivalent ratio of diamine equivalents to amine-reactive component equivalents of from 1:0.85 to 0.85:1, from 1:0.9 to 0.9:1, from 1:0.95 to 0.95:1, or from 1:0.98 to 0.98:1.

A variety of diamines can be mixed and allowed to react with the amine-reactive component to form the polyaspartate composition. Non-limiting examples can include ethylene diamine, 1,2-diaminopropane, 1,3-diaminopropane, 2,2-dimethyl-1,3-propanediamine, 1,4-diaminobutane, 1,3-diaminopentane, 1,5-diaminopentane, 1,3-diaminohexane, 1,4-diaminohexane, 1,6-diaminohexane, 2-methylpentamethylenediamine (MPMD), 2,2,4-trimethyl-1,6-diaminohexane, 2,4,4-trimethyl-1,6-diaminohexane, 1,11-diaminoundecane, 1,12-diaminododecane, 1,3-cyclohexane diamine, 1,4-cyclohexane diamine, 1-amino-3,3,5-trimethyl-5-aminomethyl cyclohexane, 2,4-hexahydrotoluylene diamine, 2,6-hexahydrotoluylene diamine, 2,2′-dimethyl-4,4′-methylenebis(cyclohexylamine), 2,4′-methylenebis(cyclohexylamine), 4,4′-methylenebis(cyclohexylamine) (PACM), diethyltoluenediamine (DETDA), 3,3′-dimethyl-4,4′-diamino-dicyclohexylmethane, the like, or a combination thereof. Additional examples of diamines can include the JEFFAMINE series of amine terminated polyethers from Huntsman Corp., such as, JEFFAMINE D-2000, JEFFAMINE D-4000, JEFFAMINE T-3000 and JEFFAMINE T-5000; and POLYETHERAMINE D 230, POLYETHERAMINE D 400, POLYETHERAMINE T 403 and POLYETHERAMINE T 5000 from BASF.

Similarly, a variety of diesters and acrylates can be mixed and allowed to react with the diamine to form the polyaspartate composition. Non-limiting examples of diesters can include dimethyl maleate, diethyl maleate, dibutyl maleate, diisobutyl maleate, dihexyl maleate, dioctyl maleate, bis(2-ethylhexyl) maleate, dimethyl fumarate, mono-methyl fumarate, diethyl fumarate, mono-ethyl fumurate, dibutyl fumarate, diisobutyl fumarate, dihexyl fumurate, dioctyl fumarate, bis(2-ethylhexyl) fumarate, the like, or a combination thereof.

Non-limiting examples of acrylates can include an alkyl acrylate, an alkyl methacrylate, the like, or a combination thereof, where the alkyl radical is a linear or branched C₁-C₁₂ alkyl radical. Non-limiting examples can include methyl acrylate, ethyl acrylate, 2-hydroxylethyl acrylate, propyl acrylate, glycidyl acrylate, butyl acrylate, hydroxylbutyl acrylate pentyl acrylate, hexyl acrylate, 2-ethylhexyl acrylate, isobornyl acrylate, methyl methacrylate, ethyl methacrylate, 2-hydroxylethyl methacrylate, propyl methacrylate, glycidyl methacrylate, butyl methacrylate, hydroxybutyl methacrylate, pentyl methacrylate, hexyl methacrylate, 2-ethylhexyl methacrylate, isobornyl methacrylate, the like, or a combination thereof.

The ratio of diester to acrylate in the amine-reactive component can depend on the particular properties to be achieved by the polyaspartate composition. For example, higher amounts of acrylate can increase the reaction rate of the polyaspartate composition with polyisocyanates. At the same time, higher amounts of acrylate can also decrease the elongation of the polyurea composition, rendering the polyurea composition increasingly brittle. Thus, the ratio of diester to acrylate can be varied to balance or achieve desired reaction rates and suitable physical properties for the intended purpose. In some examples, the amine-reactive component can include an equivalent ratio of diester equivalents to acrylate equivalents of from less than 0.9:greater than 0.1 to greater than 0.3:less than 0.7. In still additional examples, the amine-reactive component can include an equivalent ratio of diester equivalents to acrylate equivalents of from 0.85:0.15 to 0.35:0.65, from 0.8:0.2 to 0.4:0.6, from 0.7:0.3 to 0.5:0.5, from 0.6:0.4 to 0.4:0.6.

The polyaspartate compositions disclosed herein can optionally include one or more solvents. In some examples, the polyaspartate composition is not diluted in a solvent and has 100 wt % solids based on a total weight of the polyaspartate composition. In some other examples, the polyaspartate composition can optionally be diluted in a solvent. The polyaspartate composition can generally have a solids content of from 90% to 100%, or 95% to 100% based on a total weight of the polyaspartate composition. A variety of solvents can be used to dilute the polyaspartate composition and reduce the viscosity thereof. Non-limiting examples of solvents that can be employed in the polyaspartate composition can include ethyl acetate, butyl acetate, 1-methoxy propyl-acetate-2, acetone, methyl ethyl ketone, methyl isobutyl ketone, cyclohexanone, toluene, xylene, solvent naphtha, the like, or a combination thereof. In some specific examples, the solvent can include butyl acetate, methyl ethyl ketone, methoxypropylacetate, or a combination thereof. Additionally, the polyaspartate composition can generally include less than 1% water based on a total weight of the polyaspartate composition. In some additional examples, the polyaspartate composition can include less than 0.5%, or less than 0.1% water based on a total weight of the polyaspartate composition.

In some examples, the polyaspartate composition can include one or more additives. Non-limiting examples of additives can include fillers, pigments, softeners, high-boiling liquids, catalysts (such as organotin catalysts), UV stabilizers, anti-oxidants, microbiocides, algicides, dehydrators, thixotropic agents, wetting agents, flow enhancers, matting agents, anti-slip agents, aerators, extenders, the like, or a combination thereof.

Generally, the polyaspartate compositions disclosed herein can be produced by mixing the diamine with the amine-reactive component at a temperature of from 0° C. to 100° C., or from 25° C. to 70° C. In further detail, the diamine can be mixed with the amine-reactive component in a variety of ways. For example, in some cases, the diamine can be first combined with the diester and allowed to react to form a precursor polyaspartate composition including residual unreacted amine groups. The precursor polyaspartate can then be mixed with the acrylate, which can be allowed to react with remaining amine groups to form the polyaspartate composition. Alternatively, the diamine can first be combined with the acrylate and allowed to react to form a precursor polyaspartate composition including residual unreacted amine groups. The precursor polyaspartate can then be mixed with the diester, which can be allowed to react with remaining amine groups to form the polyaspartate composition. In yet an additional example, the diester and the acrylate can be pre-mixed and subsequently combined with the diamine to produce the polyaspartate composition. The reaction may take place in the presence or absence of one or more suitable solvents, such as those described above, or the like, for example. As desired, any solvent and/or unreacted monomer may be removed by distillation.

In some examples, the resulting polyaspartate composition can have an amine number of from 100 mg KOH/g to 500 mg KOH/g. In other examples, the polyaspartate composition can have an amine number of from 100 mg KOH/g to 250 mg KOH/g, 200 mg KOH/g to 350 mg KOH/g, 250 mg KOH/g to 400 mg KOH/g, or 350 mg KOH/g to 500 mg KOH/g. Amine number can be determined according to ASTM D6979-18.

In some examples, it can be desirable to minimize the amount of residual unreacted monomer in the polyaspartate composition. For example, in some cases, residual monomer can result in undesirable plasticizing effects, odors, etc. Thus, in some examples, residual reactant or unreacted monomer (e.g., fumarate, maleate, diamine, acrylate, for example) in the polyaspartate composition can be less than 5 wt % based on a total weight of the polyaspartate composition. In still additional examples, residual reactant or unreacted monomer in the polyaspartate composition can be less than 1 wt %, or less than 0.1 wt % based on a total weight of the polyaspartate composition. Residual monomer content can be measured by gas chromatography.

Additionally, in some examples it can also be desirable to minimize an amount of water in the polyaspartate composition. With this in mind, in some examples, the polyaspartate composition can include less than 1 wt % water based on a total weight of the polyaspartate composition. In further examples, the polyaspartate can include less than 0.5 wt %, or less than 0.15 wt % water based on a total weight of the polyaspartate composition. Water content can be measured by coulometric Karl Fisher titration (ASTM D6304-16e1).

As described previously, the present polyaspartate composition can have good stability. One way of measuring stability is via color. For example, APHA color is defined by ASTM D1209-05 and can be used to measure color values of polyaspartate compositions. The APHA color scale (also referred to as the Platinum Cobalt scale or Hazen scale) goes from 0 to 500 in units of parts per million of platinum cobalt to water, where 0 represents distilled water. With this in mind, the polyaspartate compositions described herein can generally have an APHA color of less than 200. In still additional examples, the polyaspartate compositions described herein can have an APHA color of less than 150, less than 100, or less than 60.

Generally, the polyaspartate compositions can have a viscosity of less than 4000 centipoise (cP) at 25° C. In some additional examples, the polyaspartate compositions can have a viscosity of less than 3500 cP or less than 3000 cP at 25° C. This can facilitate handling of the polyaspartate composition and/or subsequent mixing with other components. In some additional examples, the polyaspartate compositions can have a viscosity of from 100 cP to 500 cP, from 200 cP to 700 cP, from 500 cP to 1000 cP, from 700 cP to 1200 cP, from 1000 cP to 1500 cP, from 1200 cP to 2000 cP, from 1800 cP to 2500 cP, or from 2000 cP to 3000 cP at 25° C. Viscosity of the polyaspartate compositions can be determined at 25° C. using a Brookfield rotational viscometer according to ASTM D4878-15.

The present disclosure also describes a method of preparing a polyaspartate composition. The method can include combining a diamine and an amine-reactive component at an equivalent ratio of diamine equivalents to amine-reactive component equivalents of from 1:0.8 to 0.8:1. The amine reactive-component can include a diester and an acrylate at an equivalent ratio of diester equivalents to acrylate equivalents of from less than 0.9:greater than 0.1 to greater than 0.3:less than 0.7, or other suitable ranges as described elsewhere herein.

In some examples, the acrylate can be combined with the diamine to form a precursor composition and the diester can then be subsequently combined with the precursor composition to form the polyaspartate composition. In other examples, the diester can be combined with the diamine to form a precursor composition and the acrylate can then be subsequently combined with the precursor composition to form the polyaspartate composition. In still other examples, the diester and the acrylate can be combined to form a mixture and the mixture can then be subsequently combined with the diamine to form the polyaspartate composition.

The polyaspartate compositions described herein can be further combined with a polyisocyanate to form a polyurea coating system or composition. In other words, two-component polyurea coating systems can include a hardener/crosslinker component including a polyisocyanate, and a separate binder component including the polyaspartate composition described herein. The two separate components are generally not mixed until shortly before application because of the limited pot life of the mixture. When the two separate components are mixed, they form a polyurea coating composition which can be applied to a substrate to form a polyurea coating.

The polyisocyanate that can be combined with the polyaspartate compositions disclosed herein is not particularly limited. As used herein, the term “polyisocyanate” refers to compounds that are isocyanate-functional and comprise at least two un-reacted isocyanate groups. Thus, polyisocyanates can include diisocyanates and/or isocyanate-functional reaction products of diisocyanates comprising, for example, biuret, isocyanurate, uretdione, isocyanate-functional urethane, isocyanate-functional urea, isocyanate-functional iminooxadiazine dione, isocyanate-functional oxadiazine dione, isocyanate-functional carbodiimide, isocyanate-functional acyl urea, isocyanate-functional allophanate groups, the like, or combinations thereof.

Generally, the polyisocyanate can include any organic polyisocyanate having aliphatically, cycloaliphatically, araliphatically, and/or aromatically bound free isocyanate groups, which are liquid at room temperature or are dispersed in a solvent or solvent mixture at room temperature. In various non-limiting examples, the polyisocyanate may have a viscosity of from 10-15,000 mPa s at 23° C., 10-5,000 mPa s at 23° C., or 50-1,000 mPa s at 23° C. In certain embodiments, the polyisocyanate can include polyisocyanates or polyisocyanate mixtures having exclusively aliphatically and/or cycloaliphatically bound isocyanate groups with an (average) NCO functionality of 2.0-5.0 and a viscosity of from 105,000 mPa sat 23° C., 50-1,000 mPa sat 23° C., or 100-1,000 mPa s at 23° C. Viscosity of polyisocyanates can be determined at 23° C. according to ASTM D4889-15.

In various examples, the polyisocyanate can include polyisocyanates or polyisocyanate mixtures based on one or more aliphatic or cycloaliphatic diisocyanates, such as, for example, ethylene diisocyanate; 1,4-tetramethylene diisocyanate; 1,6-hexamethylene diisocyanate (HDI); 2,2,4-trimethyl-1,6-hexamethylene diisocyanate; 1,12-dodecamethylene diisocyanate; 1-isocyanato-3-isocyanatomethyl-3,5,5-trimethyl-cyclohexane (isophorone diisocyanate or IPDI); bis-(4-isocyanatocyclohexyl)methane (H12MDI); cyclohexane 1,4-diisocyanate; bis-(4-isocyanato-3-methyl-cyclohexyl)methane; 1,5-pentamethylene diisocyanate (PDI-bio-based) isomers of any thereof; the like; or combinations thereof. In various embodiments, the polyisocyanate component can include polyisocyanates or polyisocyanate mixtures based on one or more aromatic diisocyanates, such as, for example, benzene diisocyanate; toluene diisocyanate (TDI); xylylene diisocyanate (XDI), diphenylmethane diisocyanate (MDI); isomers of any thereof; the like; or combinations thereof. In various embodiments, the polyisocyanate component can include a triisocyanate, such as, for example, 4-isocyanatomethyl-1,8-octane diisocyanate (triisocyanatononane or TIN); isomers thereof; the like; or derivatives thereof.

Additional polyisocyanates (including various diisocyanates) that may also be included in the polyurea coating system or composition of the present invention can include the polyisocyanates described in U.S. Pat. Nos. 5,075,370; 5,304,400; 5,252,696; 5,750,613; and 7,205,356. Combinations of any of the above-identified polyisocyanates may also be used.

In some examples, the polyisocyanate resin is not diluted in a solvent and has 100 wt % solids based on a total weight of the polyisocyanate resin. In some examples, the polyisocyanate resin can be diluted in a solvent to form a polyisocyanate composition. A variety of solvents can be used to dilute the polyisocyanate resin and reduce the viscosity thereof. Non-limiting examples of solvents that can be employed in the polyisocyanate composition can include ethyl acetate, butyl acetate, 1-methoxy propyl-acetate-2, acetone, methyl ethyl ketone, methyl isobutyl ketone, cyclohexanone, toluene, xylene, solvent naphtha, the like, or a combination thereof. In some specific examples, the solvent can include butyl acetate, methyl ethyl ketone, methoxypropylacetate, or a combination thereof. In some additional examples, the polyisocyanate resin can have a solids content of from 80% to 95%, from 85% to 98%, from 90% to 99%, or from 95% to 100% based on a total weight of the polyisocyanate resin or composition.

To prepare the two-component polyurea coating compositions, the polyisocyanate and polyaspartate composition and optional additives may be mixed in any order. In some examples, the polyaspartate composition is mixed with any desired additives and then with the polyisocyanate to form the polyurea coating composition. In other examples, the polyisocyanate can be mixed with any desired additives, after which the polyaspartate composition can be introduced and mixed to form the polyurea coating composition. In still additional examples, one or more additives can be introduced into the polyisocyanate and one or more additives can be introduced into the polyaspartate composition, after which the polyisocyanate and the polyaspartate composition can be combined to form the polyurea coating composition.

The polyisocyanate and polyaspartate composition are generally mixed at an index that corresponds to a minimum equivalent ratio of isocyanate groups to amino groups. In some examples, the polyaspartate composition and the polyisocyanate are mixed at an isocyanate index of from 80 to 200. In still other examples, the polyaspartate composition and the polyisocyanate are mixed at an isocyanate index of from 85 to 180, from 90 to 150, or from 95 to 120. If polyurea compositions are desired that have better chemical resistance, then higher NCO:NH equivalent ratios can generally be used. The flexibility/hardness of the polyurea composition may be further modified, e.g., by the selection of the diamine used to prepare the polyaspartate composition, the amount of acrylate used to prepare the polyaspartate composition, etc.

The polyurea compositions described herein can be used as or in a coating, adhesive, sealant, composite, casting, or film composition, and may optionally contain additives such as fillers, pigments, softeners, high-boiling liquids, catalysts (such as organotin catalysts), UV stabilizers, anti-oxidants, microbiocides, algicides, dehydrators, thixotropic agents, wetting agents, flow enhancers, matting agents, anti-slip agents, aerators, extenders, the like, or a combination thereof. Additionally, the polyurea compositions described herein can be applied to a substrate in the form of a coating composition by conventional methods such as painting, rolling, pouring, spraying, dipping, the like, or a combination thereof. Suitable substrates include, but are not limited to, metals, plastics, wood, cement, concrete, glass, the like, or a combination thereof. In some examples, the substrates to be coated by the polyurea coating composition according to the invention may be treated with suitable primers.

A coating is also described herein. The coating can include the polyurea composition applied to at least a portion of a surface of a substrate. Suitable substrates can include metal, plastic, wood, cement, concrete, glass, the like, or a combination thereof.

A method of forming a coating on a substrate can include applying a polyurea coating composition as described herein to at least a portion of a surface of a substrate and curing the polyurea coating composition to form the coating.

In some examples, the coating can have a Shore D hardness of at least 65 within 2 hours of initial mixing (i.e., initial combination and mixing of the polyaspartate composition and the polyisocyanate composition) based on ASTM D2240-15e1. In some additional examples, the coating can have a Shore D hardness of at least 70 within 2 hours of initial based on ASTM D2240-15e1. In still additional examples, the coating can have a Shore D hardness of at least 75 or at least 78 within 2 hours of initial mixing.

### EXAMPLES

### Materials

| | |
|---|---|
| DIAMINE A | DYTEK ® A (i.e., 2- |
| | methylpentamethylenediamine), commercially |
| | available from INVISTA |
| DIAMINE B | 4,4′-Methylenebis(cyclohexylamine) |
| DIAMINE C | 4,4′-Methylenebis(2-methylcyclohexylamine) |
| ACRYLATE A | Butyl acrylate |
| ACRYLATE B | Butyl methacrylate |
| ACRYLATE C | Ethyl acrylate |
| ACRYLATE D | Isobornyl acrylate |
| ACRYLATE E | 2-Hydroxyethyl acrylate |
| DIESTER A | Diethyl maleate |
| POLYISOCYANATE A | DESMODUR N 3900 commercially available |
| | from COVESTRO AG |

### Example 1—Gel Time

A variety of polyaspartate compositions were prepared having different ratios of diester and acrylate to determine gelling time. Specifically, the DIESTER A and ACRYLATE A were combined at various ratios to form a diester/acrylate combination. The various diester/acrylate combinations were then combined at 1:1 equivalent ratios with DIAMINE A to form Polyaspartate Samples as presented in Table 1 below. The gel time was determined by mixing the various Polyaspartate Samples in Table 1 with POLYISOCYANATE A at an isocyanate index of 100.

As one non-limiting, illustrative example, Polyaspartate Sample 2 was prepared by combining 0.2 equivalents of ACRYLAYTE A with 1 equivalent of DIAMINE A to form a precursor polyaspartate composition. 0.8 equivalents of DIESTER A were then added to the precursor polyaspartate composition to form Polyaspartate Sample 2 having 1 equivalent of DIESTER A/ACRYLATE A combination per 1 equivalent of DIAMINE A. Polyaspartate Sample 2 was then combined with POLYISOCYANATE A at an isocyanate index of 100 to determine gel time.

TABLE 1
Polyaspartate Compositions and Associated Gel Times

| Polyaspartate | ACRYLATE A | DIESTER A | Gel Time |
|---|---|---|---|
| Sample | Eq. | Eq. | (seconds) |
| 1 (Comp) | 0 | 1 | 88 |
| 2 | 0.2 | 0.8 | 67 |
| 3 | 0.3 | 0.7 | 46 |
| 4 | 0.4 | 0.6 | 47 |
| 5 | 0.5 | 0.5 | 33 |
| 6 | 0.6 | 0.4 | 10 |
| 7 (Comp) | 1 | 0 | 0 |

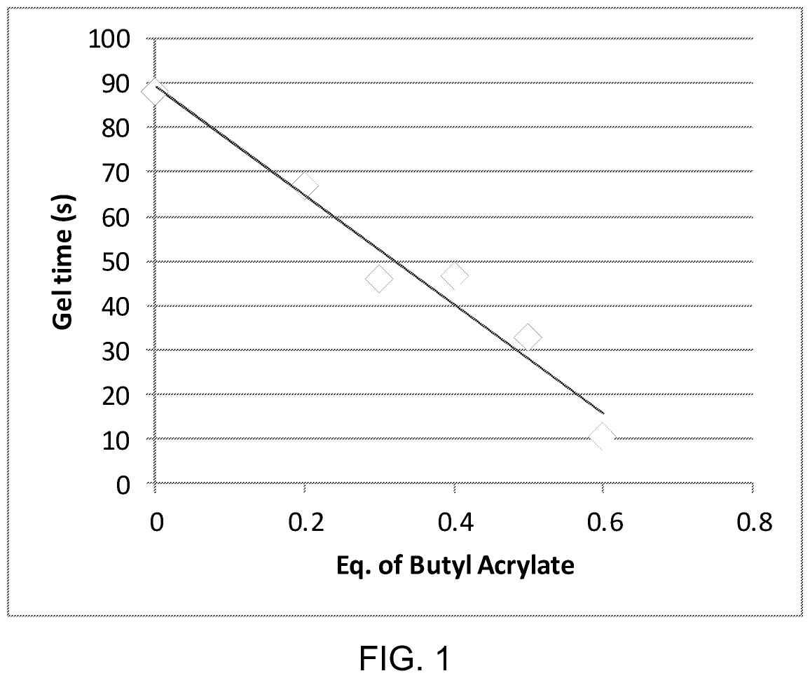

As can be seen in Table 1, increasing the proportion of butyl acrylate in the diester/acrylate combination decreased the gelling time in an approximately linear manner (See FIG. 1). However, as can be seen from Sample 7, too much acrylate can lead to excessively fast gel times. Polyaspartate samples having from 0.7 equivalents of acrylate and above gelled too quickly, and in some cases instantaneously, such as in the case of Comparative Sample 7. Such gel times, in many cases, can be problematic even for multi-component sprayable equipment.

The gel times were determined by mixing the components in a disposable beaker with a spatula until the mixture snap cured/gelled and the spatula could not be moved. The span of time from the start of mixing until solid gel formation is the gel time.

### Example 2—Stability

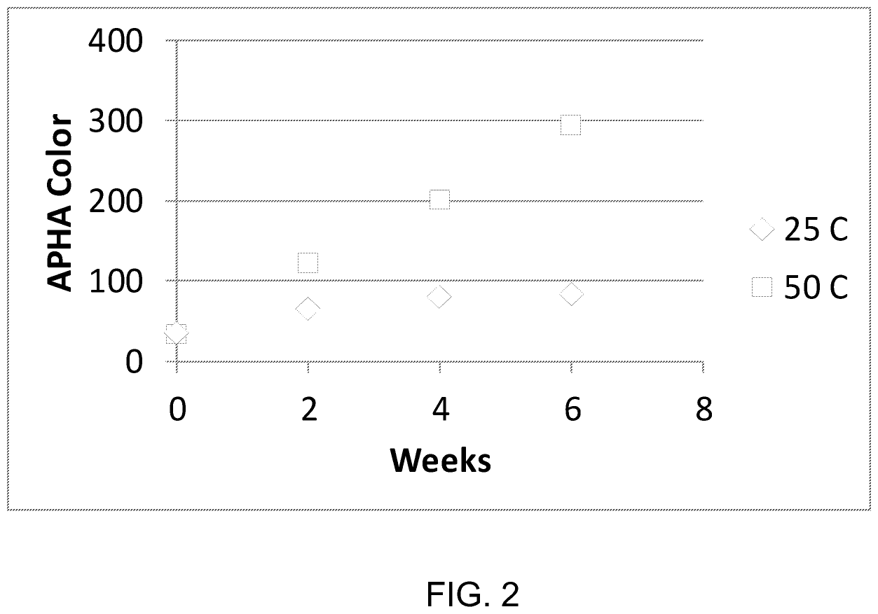

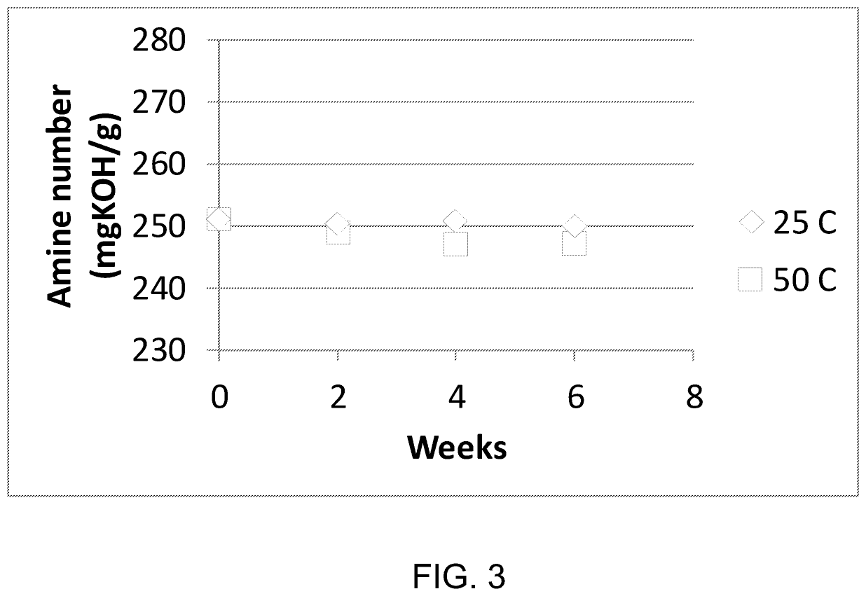

Additionally, Sample 2 was further tested to determine stability of color and amine number at 25° C. and 50° C. As can be seen in FIG. 2 and FIG. 3, both the color and the amine number were relatively stable at 25° C. Additionally, the amine number remained relatively stable even at 50° C. The color and amine number were measured according to ASTM D1209-05 and ASTM D6979-18, respectively.

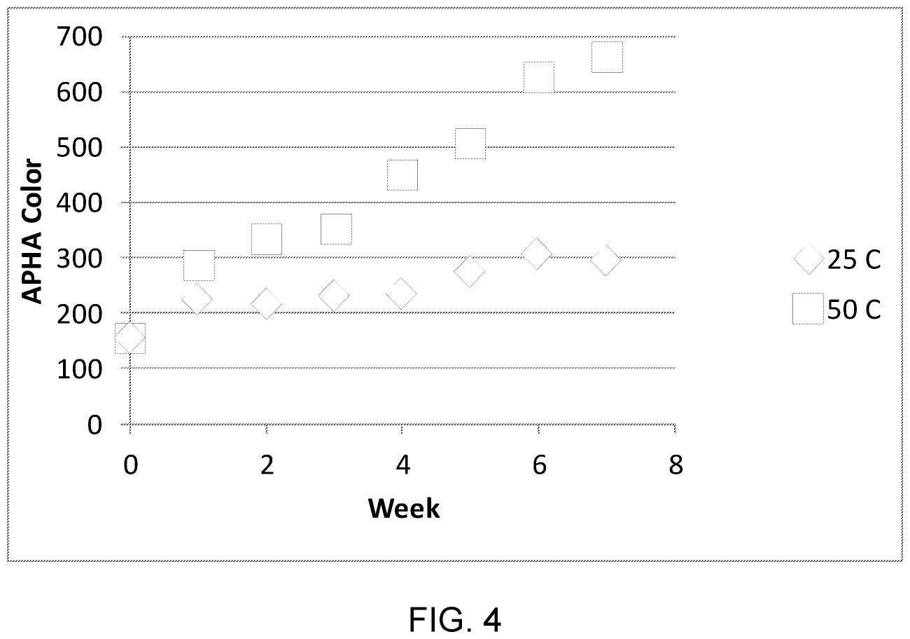

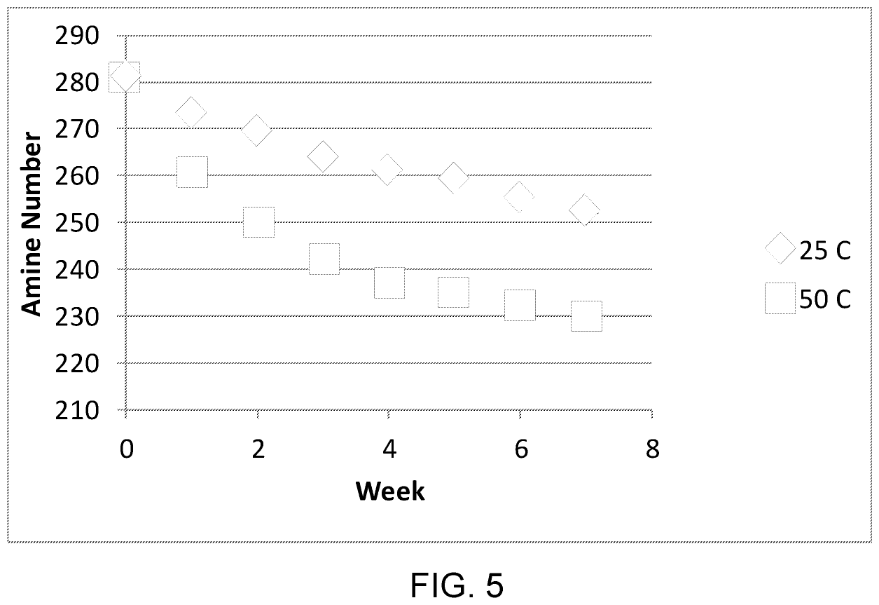

As a comparative example, an additional sample (Sample 8) was prepared that was equivalent to Sample 2, except that ACRYLATE A was removed (i.e. 0.8 equivalents of diester and 0 equivalents of acrylate). The color and amine number for Sample 8 is presented in FIGS. 4 and 5. As can be seen from FIGS. 4 and 5, Sample 8 does not demonstrate the same level of stability with respect to APHA color and amine number as Sample 2.

### Example 3—Polyaspartate Sample Variations

Additional polyaspartate sample variations were prepared as described above in Example 1, but with alternative diamines and acrylates as indicated below in Table 2. All polyaspartate sample variations were prepared with DIESTER A. Gel times were determined for each of these polyaspartate samples as described above in Example 1 by combining the polyaspartate samples with POLYISOCYANATE A at an isocyanate index of 100.

TABLE 2
Polyaspartate (PA) Sample Variations and Gel Times

| PA | Diamine | Acrylate | Acrylate | DIESTER A | Gel Time |
|---|---|---|---|---|---|
| Sample | Used | Used | Eq. | Eq. | (hour:min:sec) |
| 1 (Comp) | DIAMINE A | N/A | 0 | 1.0 | 00:01:28 |
| 9 | DIAMINE A | ACRYLATE B | 0.2 | 0.8 | 00:00:38 |
| 10 | DIAMINE A | ACRYLATE B | 0.4 | 0.6 | 00:00:13 |
| 11 (Comp) | DIAMINE B | N/A | 0 | 1.0 | 00:47:30 |
| 12 (Comp) | DIAMINE B | ACRYLATE C | 0.1 | 0.9 | 00:23:29 |
| 13 | DIAMINE B | ACRYLATE C | 0.2 | 0.8 | 00:11:58 |
| 14 | DIAMINE B | ACRYLATE C | 0.4 | 0.6 | 00:04:01 |
| 15 | DIAMINE B | ACRYLATE D | 0.2 | 0.8 | 00:07:00 |
| 16 | DIAMINE B | ACRYLATE D | 0.4 | 0.6 | 00:02:59 |
| 17 (Comp) | DIAMINE B | N/A | 0 | 0.8 | 00:04:21 |
| 18 (Comp) | DIAMINE C | N/A | 0 | 1.0 | 12:10:30 |
| 19 | DIAMINE C | ACRYLATE E | 0.2 | 0.8 | 00:11:11 |
| 20 | DIAMINE C | ACRYLATE E | 0.4 | 0.6 | 00:01:53 |

As can be seen in Table 2, in each case where an acrylate is substituted in for a portion of the diester component, the resulting polyaspartate has a faster gel time when mixed with POLYISOCYANATE A. Further, the results in Table 2 indicate that the greater the proportion of acrylate to diester in the polyaspartate, the faster the gel time when mixed with POLYISOCYANATE A, as was seen above in Table 1. However, Comparative Polyaspartate Sample 12 also establishes that inadequate amounts of acrylate substantially slow down the physical property development, as is further described in Example 4 below.

The gel times of polyaspartates prepared with DIAMINE A were determined by mixing the polyaspartates with POLYISOCYANATE A using a spatula until the mixture snap cured and formed a solid. The gel time is the time between the start of mixing and solid gel formation. The longer gel times of polyaspartates made with DIAMINE B and DIAMINE C were measured using a GARDCO gel timer.

Interestingly, Sample 16 had a faster gel time than Samples 12 and 14. Sample 16 was prepared with a reduced amount of diester, but without any acrylate (as in Sample 8 above). In this case, the gel time of Sample 16 is believed to have been faster than that of Samples 12 and 14 due to the excess primary amines present in the polyaspartate sample used in Sample 16. Sample 16 had a higher viscosity build rate and included higher molecular weight components as compared to Samples 12 and 14 (data not shown). Further, as is demonstrated in Sample 8 of Example 2, merely reducing the amount of diester in the coating composition does not produce a stable coating composition in the long-term.

### Example 4—Shore Hardness

Shore D Hardness values were determined for Polyasparate Sample variations 11-17 and 19 as shown below in Table 3. Shore D Hardness values were determined using a GARDCO hardness tester in accordance with ASTM D2240-15e1.

TABLE 3
Shore D Hardness

| PA Sample | 1 hour | 2.5 Hours | 22 hours | 70 hours |
|---|---|---|---|---|
| 11 (Comp) | Not cured | 30 | 75 | 80 |
| 12 (Comp) | 10 | 40 | 80 | 80 |
| 13 | 25 | 75 | 80 | 80 |
| 14 | 70 | 80 | 80 | 80 |
| 15 | 70 | 75 | 80 | 80 |
| 16 | 70 | 75 | 80 | 80 |
| 17 | 70 | 75 | 80 | 80 |
| 18 (Comp) | Not cured | Not cured | Partially cured* | 65 |
| 20 | 50 | 65 | 80 | 80 |

*Sample flowed under stress and a steady reading was not obtainable with the hardness meter.

As can be seen from Table 3, faster gel times also correlated with faster physical property development. However, the physical property development of Comparative Sample 12 was fairly similar to Comparative Sample 11, which included no acrylate. Samples having 0.1 equivalents of acrylate or less tended to have physical property development that was slower than desired and more comparable to samples that did not include acrylate. All inventive samples had full physical property development by about 2 hours. In contrast, all comparative samples took much longer than 2 hours to cure. Faster physical property development allows users to stack parts sooner or put parts back into service faster.

Thus, as can be seen in the examples above, substituting a portion of the diester with an acrylate can result in faster cure times and faster physical property development as compared to polyaspartates prepared with an equivalent ratio of 1:1 diester to diamine. Further, polyaspartates prepared having an equivalent ratio of acrylate equivalents to diester equivalents from greater than 0.1:less than 0.9 to less than 0.7:greater than 0.3 tended to have the best balance of fast, but manageable, cure times and faster physical property development. Faster ph Also, the presence of the acrylate improves the stability of the polyaspartate samples as compared to over-indexing the diamine relative to the diester.

It should be understood that the above-described methods are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A polyaspartate composition, comprising:
a reaction product of a diamine and an amine-reactive component, wherein the amine reactive-component comprises a diester and an acrylate at an equivalent ratio of diester equivalents to acrylate equivalents of from less than 0.9:greater than 0.1 to greater than 0.3:less than 0.7, and wherein the diamine and the amine-reactive component are combined at an equivalent ratio of diamine equivalents to amine-reactive component equivalents of from 1:0.8 to 0.8:1.

2. The polyaspartate composition of claim 1, wherein the diamine comprises ethylene diamine, 1,2-diaminopropane, 1,3-diaminopropane, 2,2-dimethyl-1,3-propanediamine, 1,4-diaminobutane, 1,3-diaminopentane, 1,5-diaminopentane, 1,3-diaminohexane, 1,4-diaminohexane, 1,6-diaminohexane, 2-methylpentamethylenediamine (MPMD), 2,2,4-trimethyl-1,6-diaminohexane, 2,4,4-trimethyl-1,6-diaminohexane, 1,11-diaminoundecane, 1,12-diaminododecane, 1,3-cyclohexane diamine, 1,4-cyclohexane diamine, 1-amino-3,3,5-trimethyl-5-aminomethyl cyclohexane, 2,4-hexahydrotoluylene diamine, 2,6-hexahydrotoluylene diamine, 2,2′-dimethyl-4,4′-methylenebis(cyclohexylamine), 2,4′-methylenebis(cyclohexylamine), 4,4′-methylenebis(cyclohexylamine) (PACM), diethyltoluenediamine (DETDA), 3,3′-dimethyl-4,4′-diamino-dicyclohexylmethane, and amine-terminated polyether, or a combination thereof.

3. The polyaspartate composition of claim 1, wherein the diester comprises dimethyl maleate, diethyl maleate, dibutyl maleate, diisobutyl maleate, dihexyl maleate, dioctyl maleate, bis(2-ethylhexyl) maleate, dimethyl fumarate, mono-methyl fumarate, diethyl fumarate, mono-ethyl fumurate, dibutyl fumarate, diisobutyl fumarate, dihexyl fumurate, dioctyl fumarate, bis(2-ethylhexyl) fumarate, or a combination thereof.

4. The polyaspartate composition of claim 1, wherein the acrylate comprises methyl acrylate, ethyl acrylate, 2-hydroxylethyl acrylate, propyl acrylate, glycidyl acrylate, butyl acrylate, hydroxylbutyl acrylate pentyl acrylate, hexyl acrylate, 2-ethylhexyl acrylate, isobornyl acrylate, methyl methacrylate, ethyl methacrylate, 2-hydroxylethyl methacrylate, propyl methacrylate, glycidyl methacrylate, butyl methacrylate, hydroxybutyl methacrylate, pentyl methacrylate, hexyl methacrylate, 2-ethylhexyl methacrylate, isobornyl methacrylate, or a combination thereof.

5. The polyaspartate composition of claim 1, comprising an equivalent ratio of diamine equivalents to amine-reactive component equivalents of from 1:0.9 to 0.9:1.

6. The polyaspartate composition of claim 1, comprising an equivalent ratio of diester equivalents to acrylate equivalents of from 0.8:0.2 to 0.4:0.6.

7. The polyaspartate composition of claim 1, wherein the composition has an amine number of from 100 mg KOH/g to 500 mg KOH/g.

8. The polyaspartate composition of claim 1, wherein the composition has a residual monomer concentration of less or equal to 5 wt % based on a total weight of the composition.

9. The polyaspartate composition of claim 1, wherein the composition comprises less than or equal to 1 wt % water based on a total weight of the composition.

10. The polyaspartate composition of claim 1, wherein the composition has an APHA color value of less than or equal to 200.

11. The polyaspartate composition of claim 1, wherein the composition has a viscosity of less than or equal to 4000 cP at 25° C. based on ASTM D4878-15.

12. A polyurea composition, comprising:
a reaction product of the polyaspartate composition of claim 1 and a polyisocyanate, wherein the polyaspartate composition and the polyisocyanate are mixed at an isocyanate index of from 80 to 200.

13. The polyurea composition of claim 12, wherein the polyisocyanate comprises ethylene diisocyanate, 1,4-tetramethylene diisocyanate, 1,6-hexamethylene diisocyanate, 2,2,4-trimethyl-1,6-hexamethylene diisocyanate, 1,12-dodecamethylene diisocyanate, 1-isocyanato-3-isocyanatomethyl-3,5,5-trimethyl-cyclohexane, bis-(4-isocyanatocyclohexyl)methane, cyclohexane 1,4-diisocyanate, bis-(4-isocyanato-3-methyl-cyclohexyl)methane, 1,5-pentamethylene diisocyanate, benzene diisocyanate, toluene diisocyanate, xylylene diisocyanate, diphenylmethane diisocyanate, 4-isocyanatomethyl-1,8-octane diisocyanate, an isomer thereof, or a combination thereof.

14. A coating, comprising the polyurea composition of claim 12 applied to at least a portion of a surface of a substrate.

15. The coating of claim 14, wherein the substrate comprises metal, plastic, wood, cement, concrete, glass, or a combination thereof.

16. A method of preparing a polyaspartate composition, comprising:
combining a diamine and an amine-reactive component at an equivalent ratio of diamine equivalents to amine-reactive component equivalents of from 1:0.8 to 0.8:1, wherein the amine reactive-component comprises a diester and an acrylate at an equivalent ratio of diester equivalents to acrylate equivalents of from less than 0.9:greater than 0.1 to greater than 0.3:less than 0.7.

17. The method of claim 16, wherein the acrylate is combined with the diamine to form a precursor composition and the diester is subsequently combined with the precursor composition to form the polyaspartate composition.

18. The method of claim 16, wherein the diester is combined with the diamine to form a precursor composition and the acrylate is subsequently combined with the precursor composition to form the polyaspartate composition.

19. The method of claim 16, wherein the diester and the acrylate a combined to form a mixture and the mixture is subsequently combined with the diamine to form the polyaspartate composition.
